(19) United States
(12) Patent Application Publication
(10) Pub. No.: US 2011/0138374 A1
(43) Pub. Date: Jun. 9, 2011

(54) DOWNTIME REDUCTION FOR ENTERPRISE MANAGER PATCHING

(76) Inventor: Suprio Pal, Fremont, CA (US)

(21) Appl. No.: 12/634,518

(22) Filed: Dec. 9, 2009

(51) Int. Cl. G06F 9/44; G06F 9/445

(52) U.S. Cl. 717/169

(57) ABSTRACT

A server identifies a group of patches. The server pushes data indicating the group of patches to each of a group of targets in such a way so that each target recognizes the patches as grouped together. At each target, the received patches are then applied to the target application as a group. As a result, target application downtime is minimized, and the target application need only be brought offline once for the entire group of patches. The patches may be applied to a target application as a single transaction. The server may determine dependencies that are required for a patch. For each target of the patch, the server identifies which of these dependencies should be installed or updated. For each target that lacks the required dependencies, the server further sends, along with the patch data, data and/or instructions that cause the target to install or update the requisite dependencies.

### FIELD OF THE INVENTION

Embodiments of the invention described herein relate generally to management of distributed system, and, more specifically, to techniques for updating software components of the distributed system.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

It is common practice for a developer of a software application to release “patches” to users of that software application. These patches modify installations of the software application, without users having to reinstall the software application. Among many other purposes, a patch may modify a software application to add or remove functionality, fix a bug or security flaw, or improve performance. Generally speaking, then, a patch may be considered to be any data that, when interpreted or executed by an appropriate patching tool, modifies an installed software application. For example, a patch to a software application may be a collection of files, data, and/or code that replaces, removes, or expands upon files, data, and/or code that have already been installed for the software application.

For convenience, a software application instance modified by a patch may hereinafter be referred to as the “target application.” A self-contained operating environment, such as an operating system or a cluster node, in which a target application executes, may hereinafter be referred to as a “target host” or “target client.” Hereinafter, the term “target,” when used by itself, may refer to either or both of the target application and the target host.

As suggested above, the process of modifying a software application based on a patch—hereinafter characterized as “applying” the patch—is typically performed by a patching tool at the target host. Typically, the patching tool interprets instructions and/or metadata distributed with a patch to determine a set of actions that the patching tool should perform to apply a patch. For example, the patch may have been distributed with instructions to copy certain files in the patch to one or more locations at which files for the software application are stored. As another example, the patch may include metadata describing how the patch is to be applied, and the patching tool may determine the best steps for applying the patch based on this metadata. As another example, the patch may include files that identify differences between certain portions of code in an installed version of the target application and a new version of the target application. The patching tool may modify and in some cases recompile code for the software application to reflect these differences, thereby updating the software application to the new version. In some cases, a patch may itself comprise executable code that is capable of modifying the software application. In such cases, one may characterize the patch as its own patching tool.

Application of a patch is typically based on one or more assumptions. If any of these assumptions are wrong, the patching tool may not be able to apply the patch successfully, and the patch is said to have failed. One of these assumptions is that the system at which the patch is to be applied already includes the software application to be patched. A more specific assumption concerns the version of the software application is installed.

Other assumptions involve the availability of certain resources (or, more specifically, resources of a certain version set) at the system at which the patch is to be applied. These resources may include, for example, resources that are necessary for the patch data to be properly interpreted (such as the patching tool itself), resources necessary to execute the patching tool (such as software libraries and development platforms), resources necessary to interpret any other instructions distributed with the patch, resources necessary to execute any executable code distributed within the patch, and resources necessary for the software application to function properly after the patch is installed. Such resources may collectively be classified as dependencies. It is often desirable or even required to install a suitable version of each dependency relied upon by a patch before applying the patch, though some dependencies may nonetheless be installed while applying a patch or thereafter.

Prior to being applied, many patches are “staged.” The process of staging, generally speaking, involves performing various preparatory tasks that are required to apply the patch, but do not modify any aspect of the software application. For example, data for a patch may be distributed as a compressed file. The process of staging the patch may entail decompressing the compressed file into a staging area, thus resulting in, for example, a directory of uncompressed files.

While being applied, certain patches require that their target applications be brought “down” or offline. For example, an instance of a software application may be running as a background process at a server. To patch this software application, the patching tool may be required to terminate the background process. In addition, if management software is monitoring the software application, a target level blackout may need to be performed. There may be many reasons for such requirements—for example, the following reasons are just some of many reasons why a patch may require that a software application be terminated: to modify or replace files that the software application locks while the software application is running; to modify the underlying format of data relied upon by the software application; to avoid data inconsistencies; and to prevent the software application from relying upon code or instructions from two different versions of the software application at the same time. Furthermore, there is often a need to restart a software application after patching regardless of any of the above factors, so as to force the software application to execute any modified executable code.

Thus, a downside to patching is that it requires that target applications be brought offline for a certain amount of time. Moreover, the patching process is fraught with glitches and bugs that can result from version conflicts, as it can be difficult for a system administrator to identify exactly which dependencies are required for the patch. These glitches and bugs result in further downtime, and this prospect of downtime discourages system administrators from applying patches as frequently as they might otherwise do.

Keeping the software components of a distributed system up-to-date through patching is often an even more time-consuming process, particularly with larger distributed systems that feature a variety of different host configurations. For example, a distributed system may feature hundreds or thousands of instances of a same software application running on a variety of different platforms on a variety of different hosts with different hardware specifications and resource availabilities. The distributed system may further feature other software components that require updating as well. Under such circumstances, ensuring that each host has the required dependencies for any given patch can be a daunting task.

Many distributed systems rely upon target-initiated patching. In such systems, targets initiate the patching process by “pulling” patch data from a server—in other words, targets send a request to the server that causes the server to return data related to patches. For example, the targets may periodically send a request to a central update server for information about the latest patches available. Based on this information, the target may select patches to download. When the target has finished downloading the patch data from the server, the target then applies each patch, one at a time.

Target-initiated patching schemes typically rely upon user supervision at the target. For example, the user may be required to instruct the target to initiate the processes of checking for patches or pulling the patches from the server. Or, the user must instruct the target to apply the patches once they have been pulled from the server. In some systems, user interaction with the target is required during the patching operation. In many cases, the responsibility for finding and/or updating dependencies is also left to the user. Thus, for a system administrator to patch each target application in a distributed system that relies upon target-initiated patching, the system administrator must assume the role of target administrator at each target the system administrator wishes to patch.

In some distributed systems, servers may “push” patches out to targets, without the target initiating the patching process. Each target is configured to listen to the server for new patch data. Meanwhile, an administrator downloads a new patch to the server. When the administrator wishes to apply the patch to target applications in the distributed system, the administrator selects the targets to be patched. The administrator then instructs the server to push that patch to the targets. When a target receives a patch, the target then initiates the patching process.

However, such systems still suffer from a variety of inefficiencies. For example, the administrator must still make sure the necessary dependencies for a patch are installed at each target host to which the patch is distributed. An administrator must also keep track of each target's configuration, so as to be able to identify to which targets a particular patch should be sent. Moreover, these systems typically require repetition of, for each patch to be applied, a process of pushing a patch to the target, waiting for the target to apply the patch, and then waiting for the target to return an indication of whether application of the patch was successful. In many cases, this process must be repeated tens or even hundreds of times, due to the large number of patches that may be released over a software application's lifespan and the potentially large numbers of targets in the distributed system.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example distributed system 100 in which various embodiments of techniques described herein may be practiced;

FIG. 2 is a flow chart illustrating a method for patching targets in a distributed system;

FIG. 3 is a flow chart illustrating a method of applying a plurality of patches to a target as a group; and

FIG. 4 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
3.0. Functional Overview
4.0. Implementation Examples
   4.1. Application of Patches as a Group
   4.2. All-or-Nothing Transaction
   4.3. Dependencies
   4.4. Credentials
   4.5. Host Configuration Data
   4.6. Patch Metadata
   4.7. Patch Compatibility Check
   4.8. Host Compatibility Check
   4.9. Receiving Patches from an External Repository
   4.10. Shared Disk Environment
   4.11. Preliminary-Scripts and Post-Scripts
5.0. Implementation Mechanism—Hardware Overview
6.0. Extensions and Alternatives

### 1.0. General Overview

Approaches, techniques, and mechanisms are disclosed for patching target applications in distributed systems. According to an embodiment, a server identifies a group of patches. The server then identifies a set of targets in the distributed system to which the group of patches are to be applied. The server pushes data indicating the group of patches to each target in such a way so that the target recognizes that the patches are grouped together. At each target, the received patches are then applied to the target application as a group. As a result, target application downtime is minimized, and the target application need only be brought offline once for the entire group of patches.

According to an embodiment, a group of patches is applied to a target application as a single transaction. Thus, if application of any one of the patches fails, application of the other patches is rolled back, and the target indicates that application of the group of patches failed. Application of the group of patches is only considered successful if all of the patches are successfully applied.

According to an embodiment, a server determines dependencies that are required for a patch. For each target of the patch, the server identifies which, if any, of these dependencies need to be installed or updated. For each target that does not have the required dependencies, the server further sends, along with the patch data, data and/or instructions that cause the target to install or update the requisite dependencies. In some embodiments, installation or updating of dependencies occurs unsupervised, without user intervention. To this end, the server may collect credentials and/or other user input necessary to install or update dependencies for a target. The server may send this information to the target along with the data indicating the dependencies.

According to an embodiment, a server in a distributed system downloads available patches from an external repository. The server then presents a list of available patches to an administrator. The administrator selects a set of patches. The server then identifies any conflicts between the patches in the group of patches, and, with or without user assistance, identifies a group of patches to be applied in the distributed system. The server then determines to which hosts in the distributed system the patches in the group of patches may be applied. The server then presents the administrator with a list of these hosts, and the administrator may identify the group of hosts to which the group of patches should be applied.

In other aspects, the invention encompasses a computer apparatus and a computer-readable medium configured to carry out the foregoing steps.

### 2.0. Structural Overview

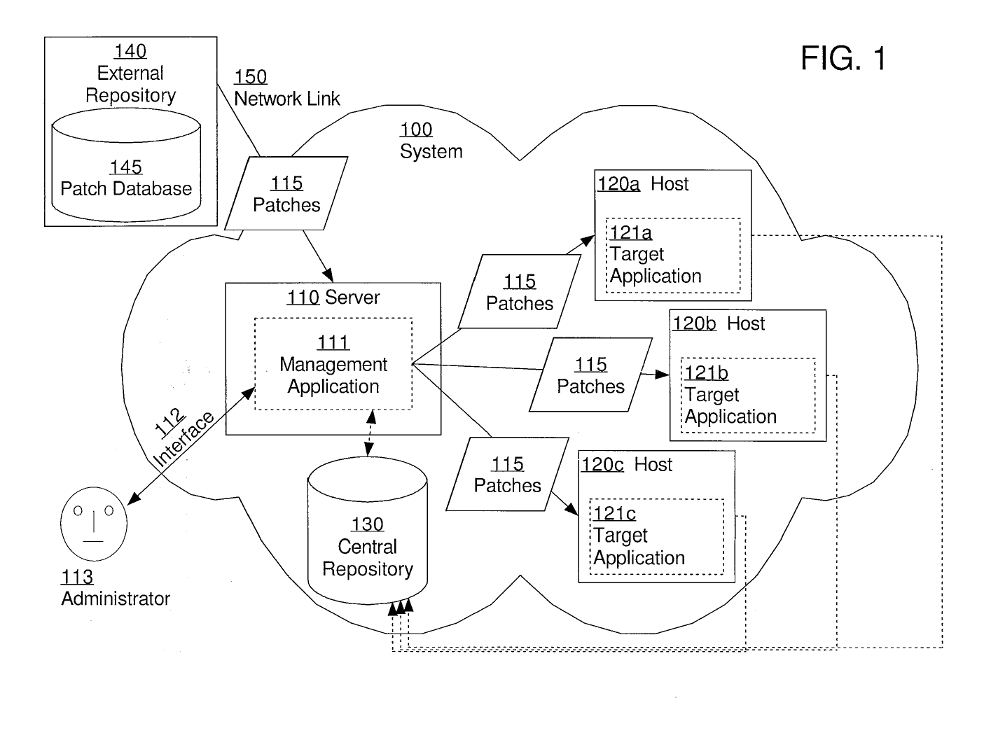

FIG. 1 illustrates an example distributed system 100 in which various embodiments of techniques described herein may be practiced. System 100 may be, for instance, a distributed system featuring various Oracle-powered components such as databases, database servers, web servers, application servers, and middleware. Among other elements (not depicted), system 100 comprises a number of hosts, including a server 110 and hosts 120a-120c.

Each of server 110 and hosts 120a-120c is a distinct operating environment in which software applications may be executed. Each of server 110 and hosts 120a-120c may run a same or different operating platform. For example, both server 110 and hosts 120a-120c may run various Linux distributions. As another example, host 120a and server 110 may run a 64 bit version of a Microsoft Windows operating system, host 120b may run a 32 bit version of a Microsoft Windows operating system, and host 120c may run a Sun Solaris operating system. Server 110 and hosts 120a-120c may run on any suitable computing device or devices.

Server 110 is distinguished from hosts 120a-120c in that it hosts, among other elements (not depicted), a management application 111 for managing various aspects of hosts 120a-120c. Management application 111 may be, for instance, Oracle Enterprise Manager. Among other aspects, management application 111 is responsible for managing patch operations at hosts 120a-120c. Management application 111 presents an interface 112 by which it may receives input from an administrator 113. Interface 112 may be, for instance, a web or other graphical user interface.

In the illustrated embodiment, each of hosts 120a-120c hosts, among other elements (not depicted) a target application 121a-121c for which management application 111 manages patch operations. Each target application 121a-121c may be any software application capable of running on its respective host. For example, each target application 121a-121c may be a different software application. As another example, each target application 121a-121c may be a separate instance of a same software application. In some embodiments, the code upon which each separate instance is based may be the same. In other embodiments, the code for each separate instance may have been compiled from substantially similar instructions, but nonetheless vary from instance to instance, depending on the platform of the host, the version of the target application 121a-121c, and other configuration issues.

According to an embodiment, each of target applications 121a-121c is an instance of a software management agent for managing various aspects of other applications at host 120a-120c respectively. In other words, target applications 121a-121c are processes with which management application 111 communicates management instructions. In response to these management instructions, target applications 121a-121c perform various tasks to manage other applications at host 120a-120c. For example, each of target applications 121a-121c may be an Oracle Management Agent. However, in other embodiments, target applications 121a-121c may be instances of a wide range of other applications.

Management application 111 pushes patches 115 to each of hosts 120a-120c. The patches, when applied to the hosts, modify target applications 121a-121c. Patches 115 are pushed to hosts 120a-120c in a group (e.g. in a single zip file). Thus, hosts 120a-120c are able to apply patches 115 together, in a single patching session, thus avoiding the need to bring target applications 121a-121c offline separately for each patch of patches 115.

System 100 further comprises a central repository 130. Central repository 130 is a data storage component at which various components of system 100 may store data to be shared with other components. For example, server 100 may download patches 115 to central repository 130, and then direct hosts 120a-120c to download the patch from central repository 130. As another example, each of hosts 120a-120c may store configuration information at central repository 130 for sharing with server 110. Other information that may be stored in central repository 130 for the managed targets includes performance data, metrics, alerts, status information, job execution history, and so on.

System 100 is connected to an external repository 140. External repository 140 is a separate system with which server 110 communicates for, among other purposes, data regarding new patches. For example, external repository may be one or more web servers provided by developers or vendors of target applications 121a-121c. External repository 140 may comprise, for instance, a patch database 145 from which patches 115 are selected. System 100 may be connected to external repository 140 via a network communication link 150 over, for example, the Internet.

System 100 is but one example of a system in which the techniques described herein may be practiced. The techniques are in fact applicable to a wide variety of systems and system architectures. For example, while system 100 includes only four hosts, the techniques described herein scale to systems many magnitudes greater in size. As another example, other applicable systems may deploy additional central repositories, may deploy central repository 130 on one or more of server 110 and hosts 120a-120c, or might lack a central repository altogether. Moreover, some hosts in an applicable system may lack the target application, while server 110 may host the target application in addition to management application 111. As yet another example, an applicable system might feature multiple management application instances executing on multiple hosts. As yet another example, management application 111 may be responsible for managing patch operations for more than one application at each of hosts 120a-120c.

### 3.0. Functional Overview

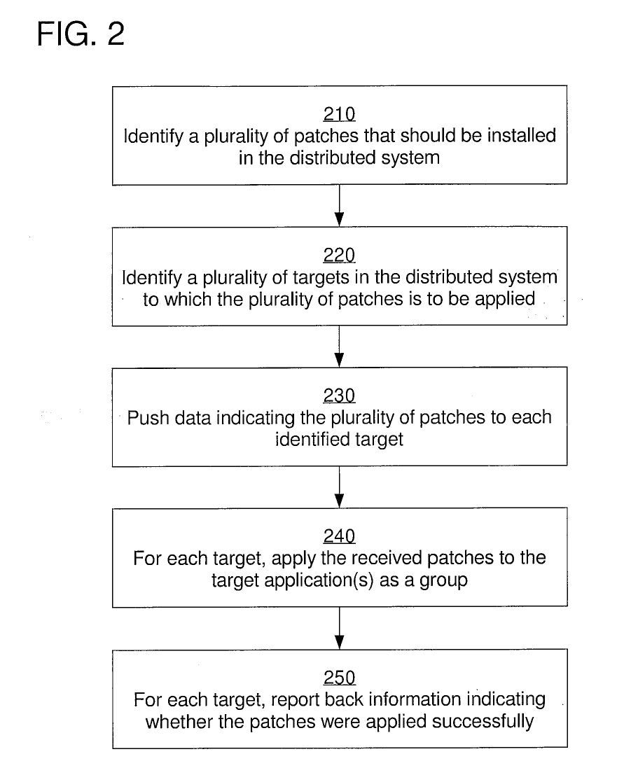

FIG. 2 is a flow chart illustrating a method for patching targets in a distributed system according to an embodiment of the invention.

At step 210, a server in a distributed system identifies a plurality of patches that should be installed in the distributed system. The server may accomplish this step in a variety of ways. For instance, server 110 may receive periodic data from external repository 140 indicating patches that are available for a certain software application. Server 110 may then automatically download to central repository 130 any patches that are not installed on one or more hosts 120a-120c. Any such patches may be collectively identified as the plurality of patches that should be installed.

As another example, server 110 may be assisted by a user in identifying the plurality of patches. For example, server 110 may again receive periodic data from external repository 140 indicating patches that are available for a certain software application. Server 110 may present a list of the patches to a user via a user interface. From this list, the user may select a group of patches to install. Server 110 may then identify this group of patches as the plurality of patches.

As another example, server 110 may rely upon patch compatibility checks and host compatibility checks to identify the plurality of patches, as discussed in sections 4.7 and 4.8, respectively. As yet another example, server 110 may utilize any of the above described techniques in tandem, so that, for instance, the list of available patches presented to the user is pre-filtered based on patch metadata and configuration data.

At step 220, the server identifies a plurality of targets in the distributed system to which the plurality of patches is to be applied. Again, the server may accomplish this step in a variety of ways. For instance, server 110 may utilize configuration data for various hosts in the distributed system to identify which of the various hosts are compatible with the plurality of patches. In some embodiments, server 110 may determine the host to be compatible with the plurality of patches if the host is compatible with each of the patches in the plurality of patches. In some embodiments, server 110 may determine the host to be compatible with the plurality of patches if the host is compatible with any one of the patches in the plurality of patches. Server 110 may determine if a host is compatible with a single patch using techniques such as those discussed in section 4.8.

As another example, server 110 may be assisted by a user in identifying the plurality of hosts. For example, server 110 may identify a list of hosts compatible with the plurality of patches determined in step 210. Server 110 may present this list of the patches to a user via a user interface. The user may then select the plurality of hosts. Or, server 110 may present to the user a list of hosts without first checking their compatibility with the plurality of patches. Once the user has selected a group of hosts, server 110 may identify the plurality of hosts by determining which hosts in the user-selected group are compatible with the patches.

At step 230, the server pushes data indicating the plurality of patches to each identified target. In contrast to target-initiated techniques, wherein targets request patch data from the server, the server initiates the transfer of patch data to the client. For example, server 110 may have identified hosts 120a and 120b as targets for a plurality of patches in step 220. Without prompting from host 120a or host 120b, server 110 may then transmit data indicating the plurality of patches to hosts 120a and hosts 120b via certain ports at hosts 120a and 120b, respectively. The ports may be, for instance, dedicated to receiving management instructions from management application 111. The ports may be kept open by software applications 121a or 121b, or by any other component of hosts 120a or 120b. As another example, server 110 may, without prompting from hosts 120a or 120b, initiate transfer of one or more files containing the data indicating the plurality of patches to folders monitored by hosts 120a and 121b respectively. Hosts 120a and 121b may periodically monitor their respective folders for new patch data.

According to an embodiment, the server pushes the patch data in such a way so that the target recognizes that the patches are grouped together. For example, server 110 may combine the plurality of patches together into a single container, such as a zip file. Because the data indicating the plurality of patches are transmitted to hosts 120a and 120b in the single container, hosts 120a and 120b recognize that the patches are grouped together. As another example, prior to sending the patch data, server 110 may transmit data indicating the start of a plurality of patches to hosts 120a and 120b. When the patch data has been completely transmitted, server 110 may transmit to hosts 120a and 120b data indicating the end of the plurality of patches.

According to an embodiment, management application 111 compresses each of patches 115 together in a single compressed file. Management application 111 then registers jobs at server 110 for sending the compressed file to each of the hosts 120a-120c, along with various parameters, metadata, instructions, and/or dependency data. Each job is executed by server 110 in due course—for instance, by a CRON process at server 110—resulting in the patches 115 being pushed to hosts 120a-120c.

At step 240, for each target, the received patches are then applied to the target application or target applications as a group. For example, in response to receiving the patch data from server 110, hosts 120a and 120b each may stage each of the plurality of patches. Hosts 120a and 120b may then apply each of the plurality of patches by modifying target applications 121a and 121b, respectively, in the manner indicated by each patch.

Application of the patches may be accomplished in any suitable way. Example techniques are discussed in section 4.1 below.

At step 250, each target reports back to the server information indicating how the patches were applied. For example, hosts 120a and 120b may send a message back to server 110 indicating whether the plurality of patches was successfully applied. Or, hosts 120a and 120b may send a message back to server 110 indicating whether each individual patch in the plurality of patches was successfully applied. Or, hosts 120a and 120b may update shared configuration data at, for instance, central repository 130, to indicate whether each individual patch in the plurality of patches was successfully applied.

Steps 210-250 are merely examples of steps that may be taken to implement the techniques described herein. The steps may be performed in orders other than described. For example, the plurality of hosts may be identified prior to or during the identification of the plurality of patches. Certain steps are optional. For example, server 110 may simply push the patch data to all hosts in the distributed system. Other steps may be added, including steps such as those described in section 4.0 below.

### 4.0. Implementation Examples

### 4.1. Application of Patches as a Group

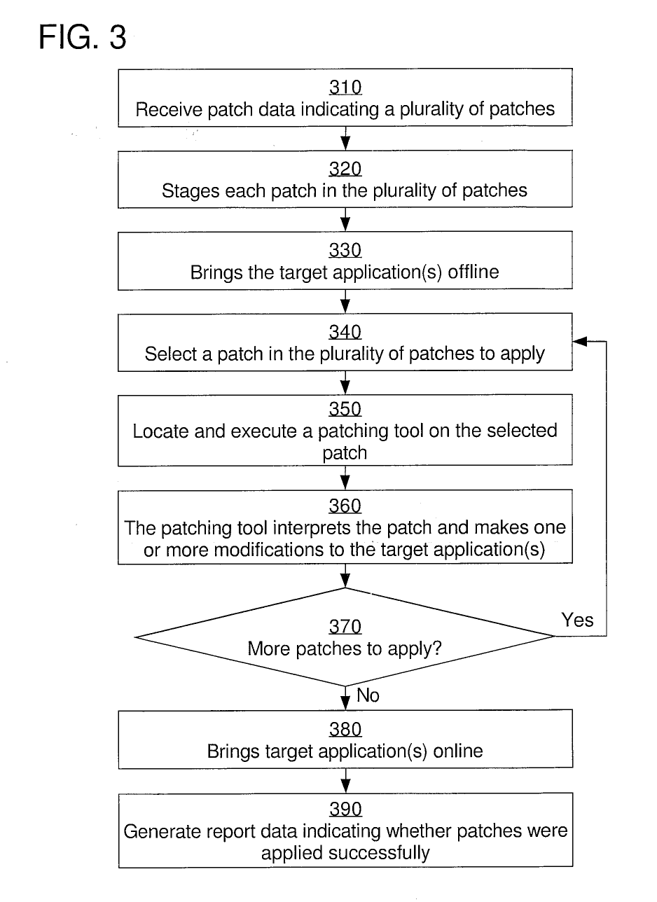

FIG. 3 is a flow chart illustrating a method of applying a plurality of patches to a target as a group, according to an embodiment of the invention.

At step 310, a host receives patch data indicating a plurality of patches, as discussed in step 230 of FIG. 2.

At step 320, in response to receiving the patch data, the host stages each patch in the plurality of patches. The host may take a variety of steps to stage a patch, including, for example, copying files distributed with the patch to a staging directory. This step may also require that the host decompress and/or explode data distributed with the patch in order to generate said files. According to an embodiment, each patch is assigned a separate directory in which files may be copied. According to an embodiment, all patches are staged in the same staging directory.

According to an embodiment, staging a patch comprises performing one or more actions that prepare the host to modify the target application. According to an embodiment, staging a patch comprises performing one or more actions that do not modify the target application, but are nonetheless necessary to apply the patch.

At step 330, the host brings the target application offline. This step may be accomplished, for instance, by sending a command to the target application that causes the target application to terminate gracefully. As another example, this step may be accomplished by sending a command to the host's operating system that causes the operating system to terminate one or more processes associated with the target application. In some embodiments, this step is performed for a target application only if one of the patches in the plurality of patches modifies files that are locked by the target application. In some embodiments, this step is performed only if one of the patches in the plurality of patches includes metadata that explicitly instructs the host to bring the target application offline. In an embodiment where the target application is being managed by a enterprise management system, the host may put the target application into a “blackout state.” In this blackout state, the target application prevents some or all generated events from being reported to the enterprise management system.

According to an embodiment, the plurality of patches may collectively apply to multiple target applications. Thus, step 330 may comprise bringing one or more of those multiple target applications offline. Patch metadata associated with each patch may assist the host in identifying target applications to take offline.

At step 340, the host selects a patch in the plurality of patches to apply. In some embodiments, prior to selection, the host performs steps to prioritize the patches in the list of patches. The selected patch in step 340 is therefore the patch in the plurality of patches with the highest priority. In other embodiments, the order in which the patches are selected is not important.

Prioritization of the patches may involve, for instance, determining patches that should be installed before other patches. Such determinations may be made, for instance, by examining patch metadata such as described in section 4.6. Prioritization of the patches may also be based on, for example, prioritization data from the server sent with the data indicating the plurality of patches. For example, the server may have computed such prioritization data for each different host, based on the configuration of each host. The server may likewise have computed prioritization data based on patch metadata.

At step 350, the host locates and executes a patching tool on the selected patch. The patching tool may be, for example, a script or application located at the host. Various items may be passed as input to the patching tool, including the patch to be applied, the target application, the location of the staging directory, the location of one or more files containing patch metadata, and so on. The same patching tool may be executed for all patches applied by the host, or the patching tool may vary from patch to patch based on, for example, patch metadata. In an embodiment, the patching tool may be included with the patch.

At step 360, the patching tool interprets the patch and makes one or more modifications to the target application of the patch based on that interpretation. According to an embodiment, the interpretation process may be as simple as recognizing that the staging directory contains one or more files and automatically interpreting the patch as indicating that the contained files should be copied to the target application directory. According to an embodiment, the interpretation process may entail recognizing that the staging directory contains one or more special scripts or binary files, and automatically interpreting the patch as indicating that those scripts or binary files should be executed.

According to an embodiment, the interpretation process may comprise interpreting one or more instructions included with the patch data. Similarly, the interpretation process may comprise reading patch metadata distributed with the patch and then making one or more decisions based on the patch metadata. Such instructions or metadata may be found, for instance, in a special file in the staging directory. Interpretation of the patch may further involve other steps not discussed above.

Based on its interpretation of the patch, the patching tool may perform a wide variety of actions that modify the software application. For example, the patching tool may copy files from the staging directory to the target application directory. The files may be copied over existing files in the target application directory, or the files may be added to the target application directory as new files. According to an embodiment, the files are stored in the staging directory using a directory structure that minors the directory structure of the target application. Thus, a file stored in the staging directory under the directory named ‘bin’ would be copied to a directory named ‘bin’ in the target application directory. If no such directory exists, the directory may be created.

As another example of actions the patching tool may perform, the patching tool may modify code or data within one or more existing files belonging to the target application. For example, the patching tool may analyze one or more “diff” files and modify code or data accordingly. As yet another example of actions the patching tool may perform, the patching tool may modify entries in a configuration file, database, or system registry that affect operation of the software application.

At step 370, if there are more patches to apply, steps 340 through 360 are repeated again for another patch. Once the host has attempted to apply all of the patches in the plurality of patches, flow proceeds to step 380.

At step 380, assuming that the target application was brought offline in step 330, the host brings the target application online by initiating execution of the target application. In embodiments where multiple target applications were brought offline, each of the multiple target applications is brought online. In an embodiment where the target application is being managed by a enterprise management system, if the target application has been put into a blackout state, the host removes the blackout for the target so that the reporting of events to the enterprise management service resumes normally.

At step 390, the host generates report data indicating whether the patches were applied successfully. The generated data may be, for example, recorded to a log, saved to a repository, and/or sent to the server from which the host received the patch data.

The above steps may be executed by any component of a host. For example, the host may execute a background process that watches for patch data per step 310, and then triggers execution of the above steps in response to receiving such patch data.

According to an embodiment, the above steps are executed by the target application itself. In other words, the target application watches for new patch data from the server. When that patch data is received, the target application then triggers the staging and application of the patches. The target application may, for example, trigger execution of the above steps by causing execution of one or more scripts or scheduled jobs—built either by the target application or distributed by the server with the patch—to perform one or more of the steps described above.

According an embodiment, a single patching tool is launched only once for all patches, instead of being launched multiple times per step 350. In this embodiment, the patching tool may be launched before one or all of steps 320-340, and the patching tool may itself be responsible for implementing one or all of steps 320-340. In such embodiments, the patching tool may also be responsible for executing one or both of steps 380 and 390.

The method flow described above is merely an example of how multiple patches may be applied as a group. Other embodiments may rely on more or fewer steps than described above, and the steps may be implemented in different orders. For example, steps 330 and 380 may in some embodiments occur while the patching tool is applying the patch. Or, steps 320 and 330 may be performed separately for each patch, just prior to the patch being applied in step 350.

In other embodiments—for instance, where each patch is staged in a same staging folder—the patching tool may interpret all of the patches at once, and take actions to apply the patches collectively without distinction between the individual patches. For example, the patching tool may simply copy all files in the staging folder to the target application directory en masse.

### 4.2. All-or-Nothing Transaction

In some cases, failures may occur as a patching tool attempts to apply a patch. The reasons for failure are plentiful. For example, a dependency may not have been correctly installed, the patching tool may be unable to interpret the patch, one or more files that should have been overwritten remained lock during the patching process, the patch incorrectly identified prerequisite versioning information, and so on. In some of these cases, the patching tool will detect such a failure during the patch operation. In other cases, the failure is not detected until the host attempts to bring the target application back online. To recover from such failures, some patching techniques implement steps for “rolling back” a patch—meaning any changes made by the patch are undone. A variety of means are available for rolling back a patch. For example, a patch may include a set of undo instructions, or the patching tool may maintain an undo log.

According to an embodiment, application of the plurality of patches is considered an all-or-nothing transaction. Depending on the embodiment, being considered an all-or-nothing transaction may have a number of ramifications. For example, in an embodiment, when any patch in the plurality of patches fails for a particular host, the host reports the entire plurality of patches as having failed. As another example, in an embodiment, when any patch in the plurality of patches fails for a particular host, the host stops applying any further patches. As another example, in an embodiment, when any patch in the plurality of patches fails for a particular host, further application of patches for that apply session is stopped and the host rolls back any patches that have already been applied.

### 4.3. Dependencies

According to an embodiment, the server may send dependency data along with the data indicating the plurality of patches. The dependency data is data such that, when interpreted by the host, causes the host to install or update one or more dependencies. For example, the dependency data may include one or more installers. As another example, the dependency data may include a set of files along with metadata or instructions that cause the host to copy the files to one or more directories for one or more dependencies. As another example, the dependency data may include instructions that cause the host to download and execute an installer for a dependency. As another example, the dependency data may include an upgraded version of a patching tool. In some embodiments, the dependency data may itself include one or more patches.

In an embodiment, the dependency data is bundled together with the data indicating the plurality of patches. For example, the dependency data may be contained inside the same compressed file in which the plurality of patches is found. In another embodiment, the dependency data is communicated to the host separately, but in association with the patch data.

The dependency data may be interpreted and acted upon by any suitable component of the host, including the patching tool, the target application, or a background process.

In an embodiment, the dependency data sent to each host differs depending upon the host's configuration. For example, for each of the plurality of targets to which the plurality of patches is to be applied, the server may consult configuration data for each host—such as the configuration data explained in section 4.5 below—to identify dependencies that are already available at the target host. The server may then compare the available dependencies to a list of dependencies required by the plurality of patches. If there is a mismatch, the server may then generate dependency data such as described above. The dependency data is then pushed to the host with the patch data.

In an embodiment, the server compiles a list of the dependencies required for the plurality of patches by determining, for each patch, a set of dependencies, and then aggregating the sets. In an embodiment, the server determines the set of dependencies for each patch using patch metadata, as discussed in section 4.6 below. In an embodiment, the server identifies additional, implicit dependencies that are required based on the dependencies explicitly mentioned in the patch data. For example, the server may maintain a database from which it may discern that a software library A requires a compiler B. If the patch identifies library A as a dependency, the server may automatically identify B as a dependency, even if B is not explicitly mentioned. In an embodiment, the server determines dependencies by analyzing the changes made by each patch, and determining resources necessary to make those changes.

### 4.4. Credentials

According to an embodiment, the server sends to each host credential data comprising one or more credentials required to perform certain tasks related to patch application at the host. For example, installation of a dependency at the host may be possible only from an account with an administrative role. As another example, certain files modified by a patch may only be modifiable by users with a certain set of privileges. In both cases, the server may therefore transmit with the dependency data a user name and password. With this data, the host may perform the appropriate login operation prior to installing the dependency.

In some embodiments, the server determines whether credential data is necessary, and transmits the credentials to the host only when necessary. In some embodiments, the server further instructs the host as to when during patch application the host should perform a login operation under the supplied credentials. In some embodiments, the server always supplies credentials. In some embodiments, the host may automatically login with any supplied credentials at a certain point in time during the patch operation—for example, just prior to step 320. In some embodiments, the host performs a login operation with the supplied credentials only if it receives a “permission denied” or like error.

According to an embodiment, once the server identifies the plurality of hosts to which the plurality of patches is to be applied, the server collects credentials for the plurality of hosts. The server may collect the credentials from a database of credentials that have previously been supplied by an administrator or the plurality of hosts. The server may also or instead prompt the user to supply credentials for one or more of the plurality of hosts. Credentials need not be collected for each host, as certain hosts may not require a login operation for the plurality of patches. Other hosts may require multiple credentials for different patch operations that the server expects to be performed for those hosts during application of the plurality of patches.

### 4.5. Host Configuration Data

According to an embodiment, various techniques described herein may rely upon configuration data indicating configuration information for various hosts in a distributed system. For each host whose configuration information is recorded in the configuration data, the configuration data may include data identifying characteristics of the host such as the platform of the host, the version of one or more software applications executing at the host, identity and version information for one or more patching tools installed at the host, identity and version information for one or more other dependencies installed at the host, patch logs indicating patches that have been or will be applied at the host along with whether those patches were successfully applied, the hosts' hardware resources, status information for said resources, and so on.

Configuration data may be stored in a variety of locations, including, for example, central repository 130. The configuration data may be collected by steps such as management application 111 tracking previous patches, management application polling hosts 120a-123c for configuration data, or hosts 120a-120c periodically sending configuration data to central repository 130.

### 4.6. Patch Metadata

According to an embodiment, various techniques described herein may rely upon metadata associated with each patch. The metadata may include data indicating characteristics of the patch such as a patch identifier, a required platform for the target host, a target application version identifier—such as a number or date—indicating the version of the target application after successful application of the patch, prerequisite target application version information indicating a version or versions of the target application to which the patch may be applied, versioning information for specific files that will be modified during application of the patch, patching tool information indicating a particular patching tool and/or version thereof necessary to apply the patch, dependency information indicating the identity of one or more dependencies and/or versions thereof necessary to apply the patch and/or execute the target application upon successful application of the patch, installation instructions, textual descriptions of changes or additions to the target application that will result from the patch, and so on.

Suitable metadata may be found, for example, within a header for each patch, within other data that accompanies each patch—e.g., in a special file with a predictable name or extension—or within database entries in association with the identifier for each patch.

### 4.7. Patch Compatibility Check

According to an embodiment, the server may utilize metadata associated with each patch, such as the metadata described in section 4.6, to select, from a group of patches, those patches that are compatible with each other. For example, server 110 may use a patch compatibility check to refine a list of patches selected by a user to those patches that are compatible with each other. The plurality of targets identified per step 210 may then include only patches that are compatible with each other.

Patch compatibility checks may be performed according to a wide variety of techniques. For example, according to an embodiment, the patch compatibility check comprises determining whether application of any one patch in the plurality of patches precludes application of another patch. For example, a first patch may update its target application from version 1 to version 3, while a second patch may update the target application from version 1 to version 2. Since application of the first patch would change the target application to a version to which the second application could not apply, the two patches are deemed incompatible. As another example, the server may determine that a first patch modifies software code or data in a manner that is inconsistent with modifications made by a second patch.

In an embodiment, the determination of whether application of any one patch in the plurality of patches precludes application of another patch takes into consideration the order in which the patches may be applied. For example, the server may determine that a first patch is compatible with a second patch as long as it is applied after the second patch. Thus, the two patches may be classified as compatible with each other. However, if a third patch must be applied before the second patch and after the first patch, the three patches may be classified as incompatible with each other.

In embodiments where each patch in the plurality of patches must be successfully applied in order for the plurality of patches to be considered successful, the patch compatibility check may comprise determining whether any of the patches require different platforms or conflicting dependencies, and thus could not be installed on the same host. For example, if one patch applied only to instances of a target application running on a Linux operating system, while another patch applied only to instances of a target application running on a Microsoft Windows operating system, the patches may be deemed incompatible.

According to an embodiment, the patch compatibility check further employs rules for determining which patch or patches to remove in the event an incompatibility is detected. For example, one rule may be to remove the smallest number of patches necessary to achieve a compatible set of patched. Other rules may take into consideration the version number or date of the patches. Other rules may select incompatible patches to remove based on preference data expressed by a user. Other rules may require specific user input identifying the patch to remove. Such rules may be hard-coded into the server, or configurable by a user.

### 4.8. Host Compatibility Check

According to an embodiment, a server may utilize host configuration data, such as described in section 4.5, to perform a host compatibility check. The host compatibility check indicates whether a patch is compatible with a certain host. The host compatibility check may serve a variety of functions.

For example, the server may utilize metadata associated with each patch, such as the metadata described in section 4.6, in conjunction with host configuration data to select, from a group of patches, patches that match certain configuration criteria. For example, server 110 may wish to use the configuration data and the metadata to determine, from a list of available patches, a group patches that have not been installed on one or more hosts in the distributed system, a group of patches that have not been installed on all of the hosts in the distributed system, a group of patches that are compatible with the indicated platforms of a certain one or more hosts in the distributed system, a group of patches whose dependencies match certain dependencies installed on one or more hosts in the distributed system, a group of patches that have failed during a previous patching attempt, and so on. The plurality of patches identified per step 210 may be based on one or more of the above discussed groups.

As another example, the server may perform host compatibility checks to identify the plurality of hosts, as explained in section 3.0 above.

A server may determine a host to be compatible with a patch based on one or more of the following factors: whether the host runs a platform identified in metadata for the patch to be a target platform for the patch, whether the host hosts a software application that matches the target application identified for the patch, whether the version of said software application is lower than the target application version of the patch, whether the version of said software application matches prerequisite version requirements for the patch, whether the host supports one or more required dependencies, whether one or more required dependencies are installed at the host, whether the management application is able to cause one or more required dependencies to be installed at the host, whether the host has access to necessary hardware resources, and so on.

4.9. Receiving Patches from an External Repository

According to an embodiment, a server may receive the plurality of patches from an external repository prior to distributing the plurality of patches to the plurality of hosts. The server, for example, may monitor the external repository for new patches and download those patches as available. As another example, the server may download metadata indicating patches that are available from the external repository on a periodic or on-demand basis. Based on the metadata, the server may present an interface to a user by which the user may select which of the available patches to download. In response to the user selecting a plurality of patches, the server may download the selected plurality of patches from the external repository. The selected patches may then be identified as the plurality of patches in step 210, or further steps may be taken to identify the plurality of patches of step 210.

According to an embodiment, an external server managing the external repository may push new patches to server 110 as they become available.

### 4.10. Shared Disk Environment

According to an embodiment, two or more target hosts may operate in a shared disk environment. For example, hosts 120a and 120b may both share a same storage system at which are stored files for the target application, such as executable files, library files, data files, and so on. Target applications 121a and 121b may be instances of the same target application invoked from the same files at the shared storage system. In such an environment, according to an embodiment, the plurality of patches only needs to be applied at one of the targets. Accordingly, one of the targets is identified as a master target. All other targets in the shared disk environment either ignore the plurality of patches, or do not receive the plurality of patches from the server. The master target brings all other target applications in the shared disk environment offline prior to modifying files in the shared storage system. The master target then brings the other target applications back online after the plurality of patches has been applied.

### 4.11. Preliminary-Scripts and Post-Scripts

According to an embodiment, the server may send to each host in the plurality of hosts one or more instructions that should be executed before or after the plurality of hosts are applied. The instructions may be transmitted with the data indicating the plurality of patches in the form of one or more pre-patch scripts or post-patch scripts. The instructions may cause the host to perform a variety of tasks, including maintenance tasks, tasks that prepare the host for applying the plurality of patches, and tasks that clean up the host after application of the plurality of patches. The instructions may be generated by the server based on, for example, an analysis of the plurality of patches, or may be provided by a user when selecting the plurality of patches and/or plurality of hosts.

### 5.0. Implementation Mechanism—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

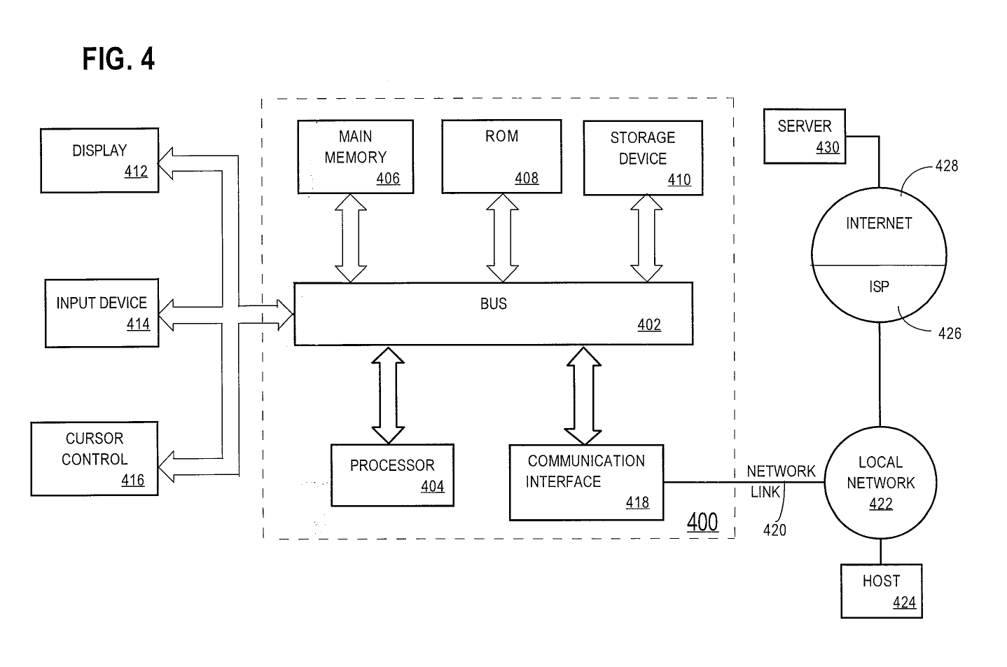

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 6.0. Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
a server identifying a plurality of patches;
the server identifying a plurality of targets to which the plurality of patches are to be applied;
the server pushing data indicating the plurality of patches to each of the plurality of targets;
at each particular target of the plurality of targets, based on the pushed data, applying the plurality of patches;
wherein the method is performed by a plurality of computing devices in a distributed system comprising the server and the plurality of targets.

2. The method of claim 1, wherein:
two or more patches of the plurality of patches must be applied, at least partially, while the particular target is offline; and
applying the plurality of patches comprises bringing the particular target offline no more than once while the plurality of patches are applied.

3. The method of claim 1, wherein pushing data indicating the plurality of patches to each of the plurality of targets occurs without one or more of the plurality of targets having requested patching.

4. The method of claim 1, further comprising:
for each particular target of one or more targets in the plurality of targets:
the server identifying one or more dependencies required for applying the plurality of patches;
the server pushing dependency data indicating the one or more dependencies to the particular target along with the data indicating the plurality of patches;
the target installing the one or more dependencies based on the dependency data.

5. The method of claim 1,
wherein applying the plurality of patches comprises applying a particular patch at a particular target of the plurality of targets;
wherein applying the particular patch is performed by a patching tool;
wherein the method further comprises, prior to applying the patch:
the server pushing dependency data to the particular target along with the particular patch;
the target updating the patching tool based on the dependency data.

6. The method of claim 1, further comprising, for each particular target of one or more targets in the plurality of targets, sending credential data to particular target, the credential data being required by the particular target for performing one or more actions necessary to apply the plurality of patches to the particular target.

7. The method of claim 1, wherein identifying the plurality of targets comprises the server selecting, from a set of all targets in the distributed system, a subset of targets that are compatible with the plurality of patches.

8. The method of claim 7, further comprising:
each target in the set of all targets sending, to a central repository, metadata describing one or more properties of said target;
wherein selecting the subset of targets comprises consulting the metadata in the central repository.

9. The method of claim 1, wherein each target of the plurality of targets is a different instance of a same application.

10. The method of claim 1, wherein:
two or more of the plurality of targets operate in a single shared disk environment;
the plurality of patches target a particular target application;
the two or more targets of the plurality of targets each execute a separate instance of the particular target application, each separate instance being invoked from shared files in the shared disk environment;
applying the plurality of patches comprises:
at each particular target of the plurality of targets, a first target of the two or more targets terminating each separate instance of the target application;
the first target modifying the shared files in accordance with the plurality of patches; and
the first target re-invoking each separate instance;
wherein the other targets of the two or more targets do not modify the shared files in accordance with the plurality of patches.

11. The method of claim 1, wherein applying the plurality of patches comprises applying each patch in the plurality of patches successfully at a first target and applying at least one patch in the plurality of patches unsuccessfully at a second target, the method further comprising, at each particular target of the plurality of targets:
if each of the plurality of patches is applied successfully, then sending a message indicating that the plurality of patches was applied successfully;
if any one of the plurality of patches is not applied successfully, then (a) reverting any patches in the plurality of patches that were not applied successfully and (b) sending a message indicating that the plurality of patches was not applied successfully.

12. One or more storage media storing instructions which, when executed by one or more computing devices, cause performance of:
a server identifying a plurality of patches;
the server identifying a plurality of targets to which the plurality of patches are to be applied;
the server pushing data indicating the plurality of patches to each of the plurality of targets;
at each particular target of the plurality of targets, based on the pushed data, applying the plurality of patches;
wherein the method is performed by a plurality of computing devices in a distributed system comprising the server and the plurality of targets.

13. The one or more storage media of claim 12, wherein:
two or more patches of the plurality of patches must be applied, at least partially, while the particular target is offline; and
attempting to apply the plurality of patches comprises bringing the particular target offline no more than once while the plurality of patches are applied.

14. The one or more storage media of claim 12, wherein pushing data indicating the plurality of patches to each of the plurality of targets occurs without one or more of the plurality of targets having requested patching.

15. The one or more storage media of claim 12, wherein the instruction, when executed by the one or more computing devices, further cause performance of:
for each particular target of one or more targets in the plurality of targets:
the server identifying one or more dependencies required for applying the plurality of patches;
the server pushing dependency data indicating the one or more dependencies to the particular target along with the data indicating the plurality of patches;
the target installing the one or more dependencies based on the dependency data.

16. The one or more storage media of claim 12, wherein the instruction, when executed by the one or more computing devices, further cause performance of, for each particular target of one or more targets in the plurality of targets, sending credential data to particular target, the credential data being required by the particular target for performing one or more actions necessary to apply the plurality of patches to the particular target.

17. The one or more storage media of claim 12, wherein identifying the plurality of targets comprises the server selecting, from a set of all targets in the distributed system, a subset of targets that are compatible with the plurality of patches.

18. The one or more storage media of claim 17, wherein the instruction, when executed by the one or more computing devices, further cause performance of:
each target in the set of all targets sending, to a central repository, metadata describing one or more properties of said target;
wherein selecting the subset of targets comprises consulting the metadata in the central repository.

19. The one or more storage media of claim 12, wherein:
two or more of the plurality of targets operate in a single shared disk environment;
the plurality of patches target a particular target application;
the two or more targets of the plurality of targets each execute a separate instance of the particular target application, each separate instance being invoked from shared files in the shared disk environment;
applying the plurality of patches comprises:
at each particular target of the plurality of targets, a first target of the two or more targets terminating each separate instance of the target application;
the first target modifying the shared files in accordance with the plurality of patches; and
the first target re-invoking each separate instance;
wherein the other targets of the two or more targets do not modify the shared files in accordance with the plurality of patches.

20. The one or more storage media of claim 12, wherein applying the plurality of patches comprises applying each patch in the plurality of patches successfully at a first target and applying at least one patch in the plurality of patches unsuccessfully at a second target, the method further comprising, at each particular target of the plurality of targets:
if each of the plurality of patches is applied successfully, then sending a message indicating that the plurality of patches was applied successfully;
if any one of the plurality of patches is not applied successfully, then (a) reverting any patches in the plurality of patches that were not applied successfully and (b) sending a message indicating that the plurality of patches was not applied successfully.
